(19) United States
(12) Patent Application Publication
(10) Pub. No.: US 2004/0192243 A1
(43) Pub. Date: Sep. 30, 2004

(54) Method and apparatus for reducing noise from a mobile telephone and for protecting the privacy of a mobile telephone user

(76) Inventor: Jaime A. Siegel, Woodcliff Lake, NJ (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/402,551

(22) Filed: Mar. 28, 2003

(51) Int. Cl. H04B 1/10

(52) U.S. Cl. 455/296; 455/67.13

(57) ABSTRACT

A method for reducing noise for a mobile telephone uses two boom microphones to create a processed voice signal with reduced noise content. A voice signal is received from a first microphone positioned near a user's mouth. A noise signal is received from a second microphone positioned at a distance from the user's mouth. A microprocessor cancels the noise signal from the voice signal and outputs the processed voice signal with reduced noise content. Another embodiment protects the privacy of a user of a mobile telephone by creating an acoustic signal from a sensed user's voice signal, which acoustic signal is an inverse of the user's voice signal. This inverse acoustic signal prevents any intelligible voice from reaching any bystanders.

### FIELD OF THE INVENTION

The present invention is directed to methods and apparatuses for communicating over a wireless link, and more particularly to a method and apparatus for communicating over wireless link, such as a mobile or cellular telephone, in a noisy environment, such as a vehicle or a crowd.

### BACKGROUND

Mobile telephones are operated in many noisy environments, which often makes it difficult to hear the speaker above the noise. In particular, when a mobile telephone is operated in a vehicle with a hands-free microphone, significant background noise is prevalent in the signal received at the other end.

This problem is often overcome by a user of a mobile telephone by speaking at an increased volume, thereby overcoming the background noise. This creates the further problem of making mobile telephone conversations easily overheard by bystanders.

The present invention is therefore directed to the problem of developing a method and apparatus for reducing noise contained in a mobile telephone signal. Moreover, the present invention is also directed to the problem of developing a method and apparatus for protecting the privacy of a mobile telephone user.

### SUMMARY OF THE INVENTION

In one exemplary embodiment, the present invention solves these and other problems by providing a second microphone (a noise microphone) disposed at a distance from the speaker who is speaking directly into a first microphone (a voice microphone) and creating a cancellation signal from the noise received by the second microphone. The cancellation signal is then added to the signal from the first microphone, thereby canceling a significant portion of the ambient noise output by the first microphone prior to the combined signal being transmitted over the wireless link.

According to one exemplary embodiment of the present invention, noise cancellation is accomplished by creating an electrical signal that is an inverse of the sensed acoustical noise by the noise microphone and adding this electrical signal to the electrical signal being output that is representative of the speaker. The resultant combined signal is then used as the cellular telephone user's signal.

According to another aspect of the present invention, a method for protecting the privacy of a mobile telephone user creates an acoustic signal that is an inverse of a voice signal sensed by a microphone and outputting this acoustic signal to cancel any acoustic signal of the mobile telephone user's voice. The resultant acoustic signal at a distance from the mobile telephone user should be unintelligible.

Finally, by combining the above two methods and apparatuses into a signal method and apparatus, reduced noise can be received by the recipient of the mobile telephone user's voice and therefore the mobile telephone user can reduce the volume of his or her voice. In addition, by outputting a canceling acoustical signal over a speaker the reduced volume acoustic signal of the mobile telephone user's voice can be more effectively cancelled.

### BRIEF DESCRIPTION OF THE DRAWINGS

FIG. 1 depicts a block diagram of an exemplary embodiment of an apparatus for reducing noise transmitted over a mobile telephone according to one aspect of the present invention.

FIG. 2 depicts a flow chart of an exemplary embodiment of a method for reducing noise transmitted over a mobile telephone according to another aspect of the present invention.

FIG. 3 depicts a block diagram of an exemplary embodiment of an apparatus for protecting a privacy of a mobile telephone user according to yet another aspect of the present invention.

FIG. 4 depicts a flow chart of an exemplary embodiment of a method for protecting a privacy of a mobile telephone user according to still another aspect of the present invention.

FIG. 5 depicts an exemplary embodiment 50 of a cellular or mobile telephone that employs the ambient noise cancellation technique according to another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Method and Apparatus for Eliminating Background Noise in a Cellular Telephone

One aspect of the present invention herein relates to a device and method for eliminating background noise that is inherent when using a hands-free microphone with a cellular telephone. An exemplary embodiment of the present invention uses a double boom microphone. The boom closest to the mouth contains a first microphone for receiving both the voice signal and the ambient noise. A second microphone is positioned to receive ambient noise. The second microphone is connected to a microprocessor. The microprocessor determines the acoustic properties of the ambient noise and creates an acoustic signal that will cancel out the majority of the ambient noise. This canceling signal can be subtracted from the acoustic signal from the first microphone to provide a clean acoustic signal containing primarily only the voice received by the first microphone.

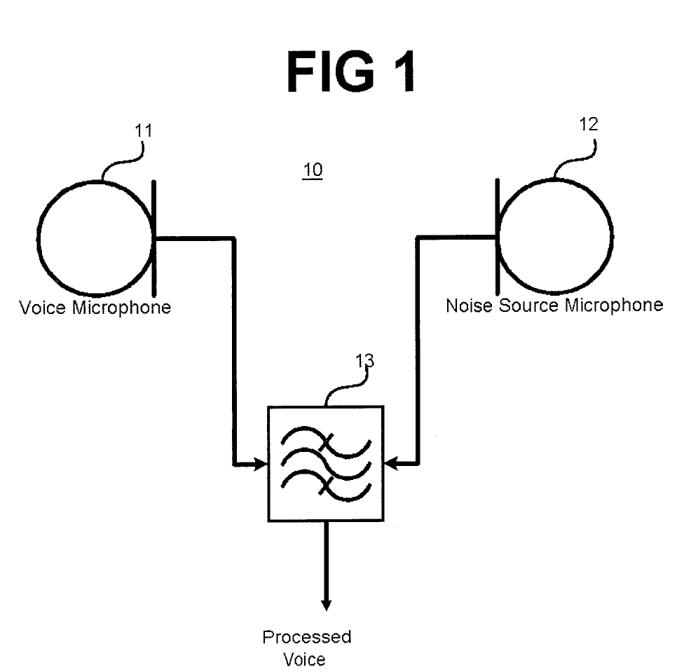

Turning to FIG. 1, shown therein is an exemplary embodiment 10 of one aspect of the present invention. A first microphone 11 is positioned closely to the user. This microphone picks up both the voice acoustic signal and the ambient noise signal. A second microphone 12 is positioned farther away from the user so that it essentially picks up only the ambient noise signal.

The outputs from these two microphones are coupled to a microprocessor 13, which is shown herein as a filter. This microprocessor characterizes the ambient noise signal and creates an inverted version of the ambient noise signal and adds the inverted signal to the signal output by the first microphone 11. The end result is a processed voice signal that can then be forwarded through the cellular network in the usual manner. The processed voice signal now contains significantly reduced noise content.

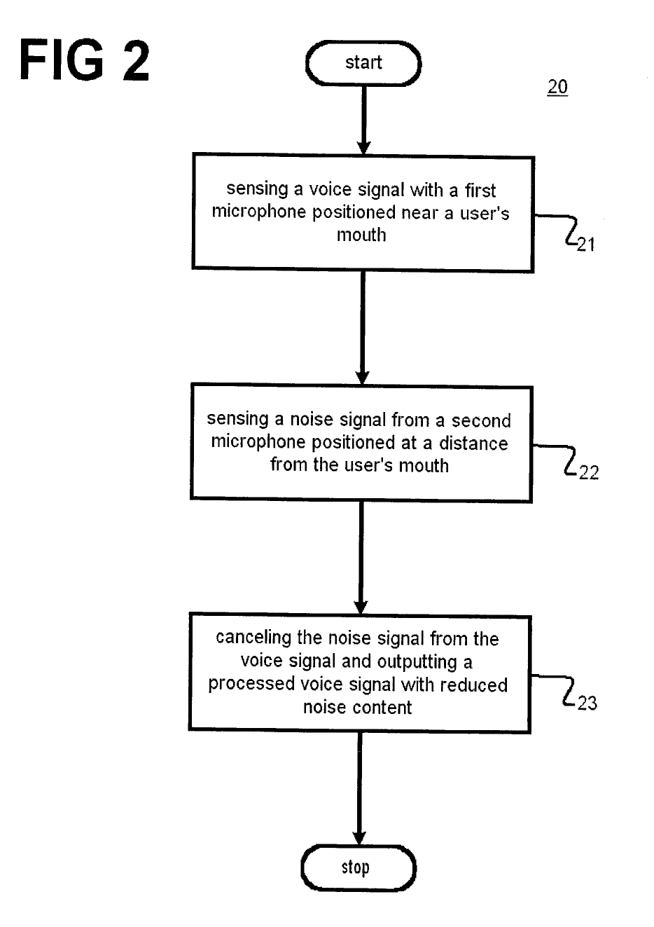

Turning to FIG. 2, shown therein is an exemplary embodiment 20 of a method for eliminating background noise in a cellular telephone. A voice signal is sensed with a first microphone positioned near a user's mouth (element 21). A noise signal is simultaneously sensed with a second microphone positioned at a distance from the cellular telephone user's mouth (element 22). The noise signal is cancelled from the voice signal by creating an inverse signal indicative of the noise signal received, which inverse signal is added to the user's voice signal; a processed voice signal is then output with reduced noise content (element 23). The end result is that a recipient of the cellular telephone user's voice over the cellular network will receive a signal that includes mostly the voice of the cellular telephone user in the noisy environment.

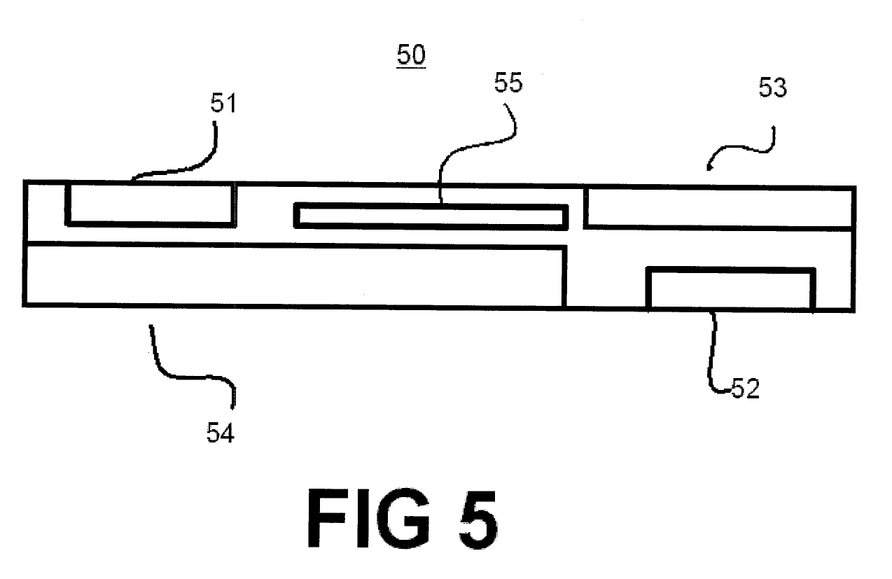

Turning to FIG. 5, shown therein is an exemplary embodiment 50 of a cellular or mobile telephone that employs the ambient noise cancellation technique discussed above. In this embodiment 50, a voice microphone 51 is disposed on the front face of the cellular telephone to pick up as much of the voice signal as possible. An ambient noise microphone 52 is disposed on the opposite side of the cellular telephone 50 or back face to pick up the ambient noise signal. The front face of the cellular telephone 50 typically includes the screen 53 and the back typically includes the battery module 54. As in the above embodiment, a processor 55 cancels ambient noise signal from the voice signal (which naturally includes the ambient noise signal) and the end result is a stronger voice signal relative to the ambient noise. The stronger voice signal is then transmitted over the cellular network in the normal manner. The ambient noise microphone could be positioned elsewhere on the cellular telephone, but most importantly it should be located as far away from the user's mouth.

Method and Apparatus for Protecting the Privacy of a Cellular Telephone User

According to another aspect of the present invention, a method and apparatus is disclosed for protecting the privacy of a cellular telephone user. This method and apparatus prevent bystanders from listening to a cellular phone user that is speaking into a hands-free microphone.

According to one exemplary embodiment of the present invention, a single boom or double boom microphone can be employed. The apparatus includes a microphone into which the user speaks and a speaker for transmitting an acoustical signal. The microphone is connected to a microprocessor and the microprocessor determines the acoustic signal of the cellular telephone user's voice. The microprocessor creates an acoustic signal that will cancel out the majority of the voice of the telephone user. The acoustic signal is then output by the speaker so that beyond the speaker virtually none of the cellular telephone user's voice is intelligible.

As an example, to generate an acoustic signal, one can employ a piezoelectric sound source as disclosed in U.S. Pat. No. 5,386,479. This light compact device enables the creation of an acoustic signal over a broad frequency range. As such, the piezoelectric sound source can be used to generate the necessary acoustic signals. U.S. Pat. No. 5,386,479 is hereby incorporated by reference as if repeated herein in its entirety, including the drawings.

The microprocessor performs all necessary calculations to instruct the acoustic generator as to the characteristics of the acoustic cancellation signal. U.S. Pat. No. 4,473,906 discloses one method and device for creating these necessary acoustic signals. U.S. Pat. No. 4,473,906 is hereby incorporated by reference as if repeated herein in its entirety, including the drawings.

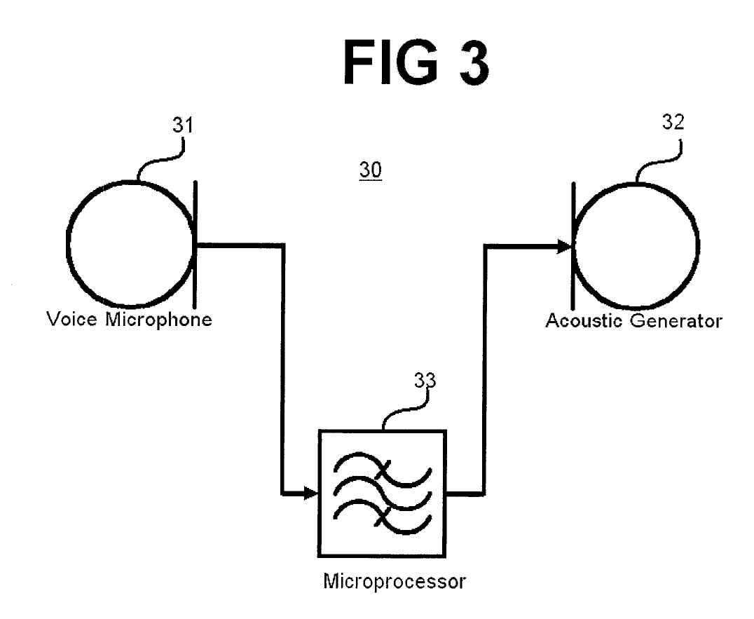

Turning to FIG. 3, shown therein is an exemplary embodiment 30 of another aspect of the present invention. A microphone 31 is positioned closely to the user. This microphone picks up the voice signal of the cellular telephone user. A microprocessor 33 determines the acoustical characteristics of the cellular telephone user and creates an electrical signal indicative of these acoustical characteristics. The electrical signal is then passed to an acoustic generator 32 (or a speaker), which generates the desired signal to cancel the cellular telephone user's voice. The end result is that the cellular telephone user's voice acoustic wave is substantially cancelled by the acoustic signal output by the acoustic generator 32 so that at a distance from the cellular telephone user the two acoustic signals combine so that no intelligible conversation can be discerned.

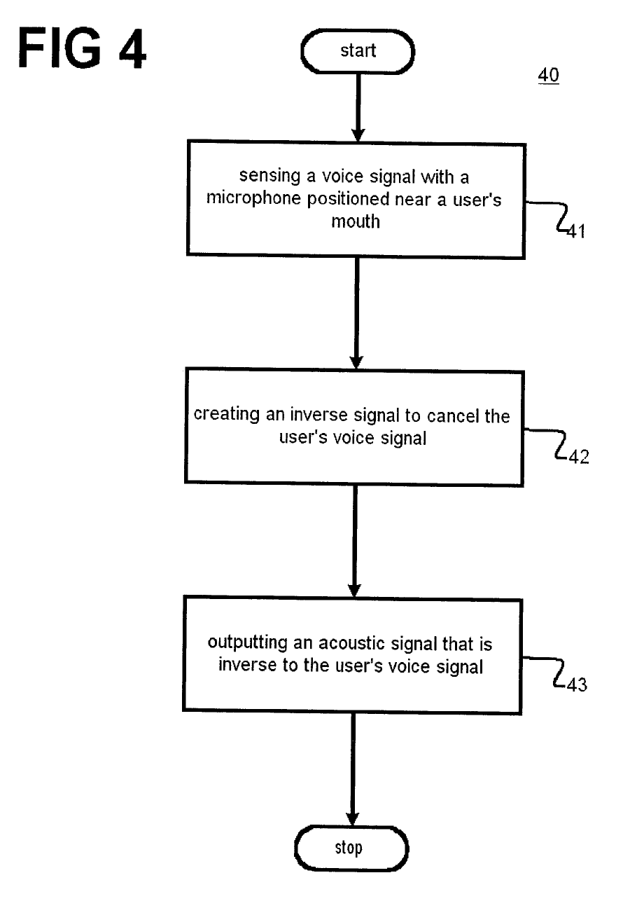

Turning to FIG. 4, shown therein is an exemplary embodiment 40 of a method for protecting the privacy of a cellular telephone user. A voice signal is sensed by a microphone positioned near a user's mouth (element 41). An inverse signal is created to cancel the user's voice signal (element 42). An acoustic signal is then output that is inverse to the user's voice signal (element 43). The end result is that a bystander in hearing range of the cellular telephone user's conversation will receive an acoustic signal that is a combination of the acoustic signal of the cellular telephone user's voice and an inverse acoustic signal of the same thing, providing an end resulting acoustic signal that masks the cellular telephone user's voice so that no intelligible conversation can be discerned.

Combined Method and Apparatus for Eliminating Background Noise in a Cellular Telephone and Protecting the Privacy of a Cellular Telephone User

Combining the above two methods and apparatuses into a single method and apparatus, reduces noise that is received by the recipient of the mobile telephone user's voice. As a result, the mobile telephone user can reduce the volume of his or her voice, which in turn reduces the distance over which the user's acoustic voice signal will travel to unintended listeners. The processor also outputs a canceling acoustical signal over a speaker, which more effectively masks/cancels the acoustic signal of the user's voice.

Although various embodiments are specifically illustrated and described herein, it will be appreciated that modifications and variations of the invention are covered by the above teachings and are within the purview of the appended claims without departing from the spirit and intended scope of the invention. For example, the present invention has been described in relation to a mobile telephone, however, the same technique could be applied to a standard telephone. Furthermore, this example should not be interpreted to limit the modifications and variations of the inventions covered by the claims but is merely illustrative of one possible variation.

What is claimed is:

1. A method for reducing noise that is transmitted over a mobile telephone comprising:
sensing a voice signal of a mobile telephone user with a first microphone;
sensing a noise signal of the ambient noise around the mobile telephone with a second microphone; and
canceling the noise signal from the voice signal and forwarding over the mobile telephone a processed voice signal with reduced noise content.

2. The method according to claim 1, wherein the first microphone is positioned near a mouth of the mobile telephone user.

3. The method according to claim 1, wherein the second microphone is positioned at a distance from a mouth of the mobile telephone user relative to a position of the first microphone.

4. The method according to claim 1, wherein the canceling includes creating an inverted noise signal from the sensed noise signal and adding the inverted noise signal to the sensed voice signal to create the processed voice signal.

5. An apparatus for reducing ambient noise for a mobile telephone comprising:
a first microphone to sense a voice signal of a mobile telephone user;
a second microphone to sense a noise signal of the ambient noise around the mobile telephone; and
a processor coupled to the first and second microphones to cancel the sensed noise signal from the sensed voice signal and to output a processed voice signal with reduced noise content.

6. The apparatus according to claim 5, wherein the first microphone is positioned near a mouth of the mobile telephone user.

7. The apparatus according to claim 5, wherein the second microphone is positioned at a distance from the mouth of the mobile telephone user relative to the first microphone.

8. The apparatus according to claim 5, wherein the processor creates an inverted noise signal from the sensed noise signal and adds the inverted noise signal to the sensed voice signal to create the processed voice signal.

9. A method for protecting a privacy of a mobile telephone user comprising:
sensing a voice signal of the mobile telephone user;
creating an acoustic signal inverse to the sensed voice signal; and
outputting the inverse acoustic signal.

10. The method according to claim 9, wherein a microphone positioned near a mouth of the mobile telephone user senses the voice signal.

11. The method according to claim 9, wherein the inverse acoustic signal is output by an acoustic transmitter positioned near the mobile telephone user.

12. An apparatus for protecting a privacy of a mobile telephone user comprising:
a microphone to sense a voice signal of the mobile telephone user;
a processor coupled to the microphone to create a signal inverse to the sensed voice signal; and
an acoustic transmitter controlled by the processor and outputting an acoustic signal inverse to the sensed voice signal.

13. The apparatus according to claim 12, wherein the microphone is positioned near a mouth of the mobile telephone user.

14. The apparatus according to claim 12, wherein the acoustic transmitter is positioned near the mobile telephone user.

15. The apparatus according to claim 12, where the acoustic transmitter is an acoustic speaker.

16. A method for reducing noise that is transmitted over a mobile telephone and for protecting a privacy of a mobile telephone user comprising:
sensing a voice signal with a first microphone;
sensing a noise signal with a second microphone;
canceling the noise signal from the voice signal and outputting a processed voice signal with reduced noise content;
creating a signal inverse to the voice signal sensed by the first microphone; and
outputting an inverse acoustic signal through an acoustic transmitter positioned near the mobile telephone.

17. The method according to claim 16, wherein the first microphone is positioned near a mouth of the mobile telephone user.

18. The method according to claim 16, wherein the second microphone is positioned at a distance from a mouth of the mobile telephone user relative to a position of the first microphone.

19. The method according to claim 16, wherein the canceling includes creating an inverted noise signal from the sensed noise signal and adding the inverted noise signal to the sensed voice signal to create the processed voice signal.

20. The method according to claim 16, wherein the inverse acoustic signal is output by a speaker positioned near the mobile telephone user.

21. An apparatus for reducing noise for a mobile telephone and for protecting a privacy of a mobile telephone user comprising:
a first microphone to sense a voice signal;
a second microphone to sense a noise signal;
a processor coupled to the first and second microphones to cancel the noise signal from the voice signal, to output a processed voice signal with reduced noise content, and to create an inverse signal that is inverse to the sensed voice signal; and
an acoustic transmitter coupled to the processor to output an acoustic signal inverse to the voice signal.

22. The apparatus according to claim 21, wherein the first microphone is positioned near a mouth of the mobile telephone user.

23. The apparatus according to claim 21, wherein the second microphone is positioned at a distance from the mouth of the mobile telephone user relative to the first microphone.

24. The apparatus according to claim 21, wherein the processor creates an inverted noise signal from the sensed noise signal and adds the inverted noise signal to the sensed voice signal to create the processed voice signal.

25. A portable telephone comprising:
a voice microphone to receive a voice signal;
an ambient noise microphone to receive an ambient noise signal;
a processor coupled to the voice microphone and the ambient noise microphone to cancel the ambient noise signal from the voice signal.

26. The portable telephone according to claim 25, wherein the ambient noise microphone is disposed on an opposite side of the portable telephone from the voice microphone.

27. The portable telephone according to claim 25, wherein the ambient noise microphone is disposed on an opposite side and at an opposite end of the portable telephone with respect to the voice microphone.
